(19) United States
(12) Patent Application Publication
(10) Pub. No.: US 2004/0074400 A1
(43) Pub. Date: Apr. 22, 2004

(54) Apparatus and method for roasting coffee beans

(76) Inventor: Eugene Song, Seoul (KR)

Correspondence Address: ROBERT D. FISH; RUTAN & TUCKER, LLP, P.O. BOX 1950, 611 ANTON BLVD., 14TH FLOOR, COSTA MESA, CA, 92628-1950, US

(21) Appl. No.: 10/666,665

(22) Filed: Sep. 17, 2003

(30) Foreign Application Priority Data
Sep. 18, 2002 (KR) 2002-56889

(51) Int. Cl. A23C 3/02

(52) U.S. Cl. 99/483

(57) ABSTRACT

A coffee roaster and a method for roasting beans are disclosed. The coffee roaster comprises a chamber for containing beans, a temperature adjusting means for heating or cooling the beans and the chamber, a temperature measuring means located within the chamber for measuring a beans' temperature and a chamber's temperature, and a controller. The controller calculates a first beans' temperature and a first maintain time based on the weight and a type of raw beans. The controller also controls the temperature adjusting means in order to maintain the chamber temperature as a first chamber temperature during a first maintain time when the beans' temperature reaches the first beans' temperature, and in order to continuously heat the beans during a roasting process.

### TECHNICAL FIELD OF INVENTION

The present invention is related to a coffee roaster, more particularly, an apparatus and a method for automatically roasting coffee beans by controlling the roasting process based on temperature and time.

### BACKGROUND OF THE INVENTION

Generally, a coffee roaster for a commercial shop is an apparatus for roasting coffee beans by using a gas heater or an electronic heater. An expert takes beans sample from a chamber by using a tool, and then observes roasting grade of the coffee beans by the naked eye. After observing, the expert controls directly the gas heater or the electronic heater so as to roast the beans. At this time, the water contained in the beans is evaporated and the size of the beans respectively is swelled. After the roasting process, the beans extracted from the chamber are cooled down at 1 through 2 degrees centigrade lower than the periphery temperature for 5 minutes. In the cooling process, the pill of the beans becomes harder so as to be able to keep the beans for relatively long periods.

However, a conventional coffee roaster for the commercial shop is voluminous and heavier, and consumes lots of electric power. Also, the user empirically and manually roasts the coffee beans by using the conventional coffee roaster so that the user should be an expert.

Moreover, the smoke eliminator or exhaust device that processes the large amount of smoke generated during the roasting process should be mounted on a separate place from the coffee roaster. Another problem is the difficulty in that the temperature needs to be detailedly controlled by the gas heater or the electronic heater. The other problem is that it is hard to discharge the hot beans from the chamber.

Furthermore, quantity of heat affects the beans in the final result according to the type of beans, moisture content, and hardness of beans pill. Because the users' tastes for the roasting beans are so different, it is difficult to obtain the final result of the roasting beans which is always satisfying to the users' tastes. Additionally, when the power is abruptly broken during the roasting process, oil generated from beans burns as residual heat so as to generate a fire.

It is an object of the present invention to provide an apparatus and a method which are capable of calculating roasting temperatures according to a type of the raw beans and a weight of the raw beans in order to achieve optimized roast characteristics.

It is another object of the present invention to provide an apparatus and a method, which are capable of cooling the beans with selectively supplying water after roasting within the chamber.

It is a further object of the present invention to provide an apparatus, which is capable of automatically loading and unloading the beans without touching the chamber.

It is a further object of the present invention to provide an apparatus which is capable of keeping smoke generated during the roasting process of the beans until the beans' temperature reaches a predetermined temperature in order to improve the quality of taste and smell of the roasted beans.

These and further characteristics of the present invention will become more readily apparent when considering the following disclosure and appended claims.

### SUMMARY OF THE INVENTION

The above objects are achieved in the present invention which relates in one aspect to an apparatus for roasting beans comprising an electronic scale, a chamber, a temperature adjusting means including a halogen light heater, a temperature measuring means for measuring a beans' temperature and a chamber's temperature, and a controller. The controller calculates a first beans' temperature and a first maintain time based on the weight of the raw beans and a type of raw beans, and also controls the temperature adjusting means in order to maintain the chamber temperature as a first chamber temperature during a first maintain time when the beans' temperature reaches the first beans' temperature, and in order to continuously heat the beans during a roasting process. The apparatus further includes a water provider. In that case, the controller calculates an amount of the water according to the raw weight, and when after the roasting process, the water pump operates so as to shoot out the calculated amount of the water by the nozzle through the water tank.

The apparatus further comprises a cool air blower for blowing into the chamber external air, and an exhaust fan for exhausting inner air of the chamber. The exhaust fan operates with a first speed in order to exhaust smoke within the chamber during the roasting process, and the exhaust fan operates with a second speed in order to cool down the beans after the roasting process, wherein the fist speed is less than the second speed.

The apparatus also further comprises a damper includes a first shutter and a second shutter. The first shutter is firstly opened during a predetermined time when the chamber temperature becomes a predetermined temperature, and is secondly opened during the maintain time when the beans temperature becomes the first temperature, and is lastly opened when the beans temperature becomes a second temperature.

Furthermore, the apparatus further comprises a smoke exhaust means for burning and exhausting smoke generated during the roasting process. The smoke exhaust means includes a smoke eliminator for burning the smoke discharged from the chamber, and a funnel for exhausting the smoke burnt in the smoke eliminator. Selectively, the smoke exhaust means includes an exhaust fan for periodically operating during a predetermined time period; and an smoke eliminator for burning the smoke exhausted by operating the exhaust fan.

The apparatus further comprises a providing means for providing the raw beans into the chamber and a discharging means for discharging the beans after cooling down the beans at a predetermined temperature.

A method for roasting beans comprises a) storing weight of raw beans; b) discriminating whether certain type of the raw beans has been inputted; c) calculating a first beans' temperature and a maintain time based on the weight of the raw beans and the type of the raw beans according to the discriminated result; and d) adjusting a beans' temperature and a chamber temperature by heating or cooling; wherein the step d) includes the steps d-1) maintaining the chamber temperature as a first chamber temperature during a first maintain time when the beans' temperature reaches the first beans' temperature; d-2) adjusting the beans' temperature which is lower than a predetermined beans' temperature; and d-3) decreasing or increasing a compensating time based on the an applied voltage when the chamber's temperature is a predetermined temperature.

In the method of the present invention, the step c) includes steps of c-1) automatically being set as a predetermined type when the type of the raw beans is unselected in a discriminated result of the step b); c-2) setting on a basis of the first beans' temperature when the type of the beans is the predetermined type and the weight of the beans exceeds a predetermined weight; c-3) decreasing the first beans' temperature by a predetermined degrees when the weight of the beans is less than the predetermined weight; and c-4) increasing or decreasing the first beans' temperature according to selection of the type of the raw beans when the type of the raw beans is inputted by the user.

### BRIEF DESCRIPTION OF THE DRAWINGS

FIG. 1 and FIG. 2 respectively are a front and a rear view of the beans roaster of the present invention.

FIG. 3 is perspective view showing the exploded state of the present invention.

FIG. 4 is a cross-sectional side view of the coffee roaster of the present invention.

FIG. 5 is showing a front cross-sectional view in order to depict the operating state of the coffee roaster according to a first embodiment of the present invention.

FIG. 6 is showing a front cross-sectional view in order to depict the operating state of the coffee roaster according to a second embodiment of the present invention.

FIGS. 7 and 8 respectively are showing an smoke eliminator of the coffee roaster shown in FIG. 5 or 6.

FIG. 9a and FIG. 9b respectively are a cross sectional view and a sectional view of an exhaust duct of the coffee roaster according to present invention.

FIG. 10 is a schematic block diagram of a controlling system for the coffee roaster according to the present invention.

FIG. 11 is a circuit of the coffee roaster according to the present invention.

FIG. 12 is a flow diagram of the roasting control process according to the present invention.

FIG. 13 is a graph of the temperature and time controlled by the flow diagram shown in FIG. 12.

### BEST MODE FOR CARRYING OUT THE INVENTION

Hereinafter, preferred embodiments of present invention will be described in detail with reference to the accompanying drawings.

In this invention, coffee seed before roasting process will be described as “Raw Beans” and the coffee seed after the roasting process will be described as “Beans”.

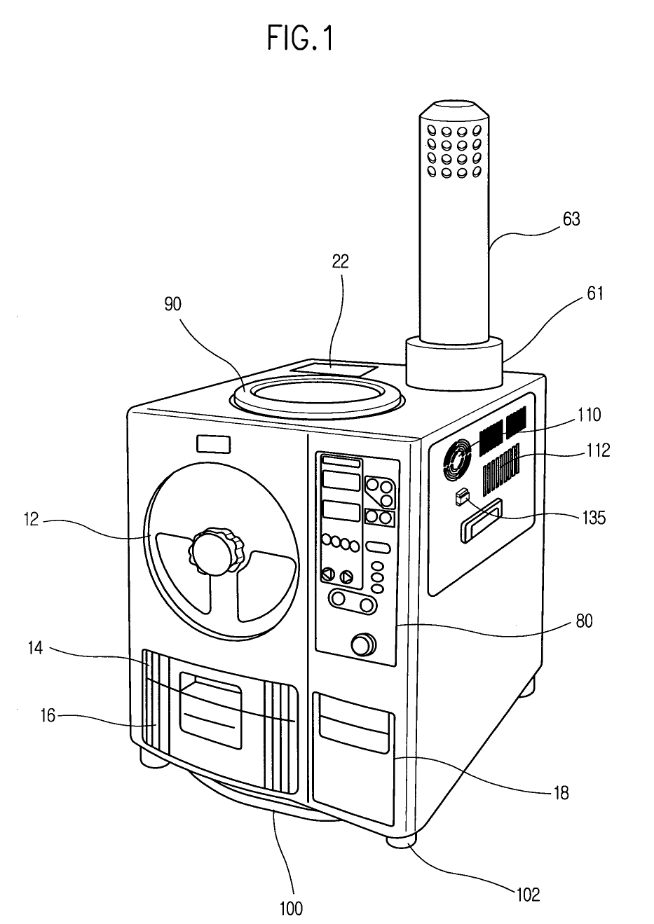

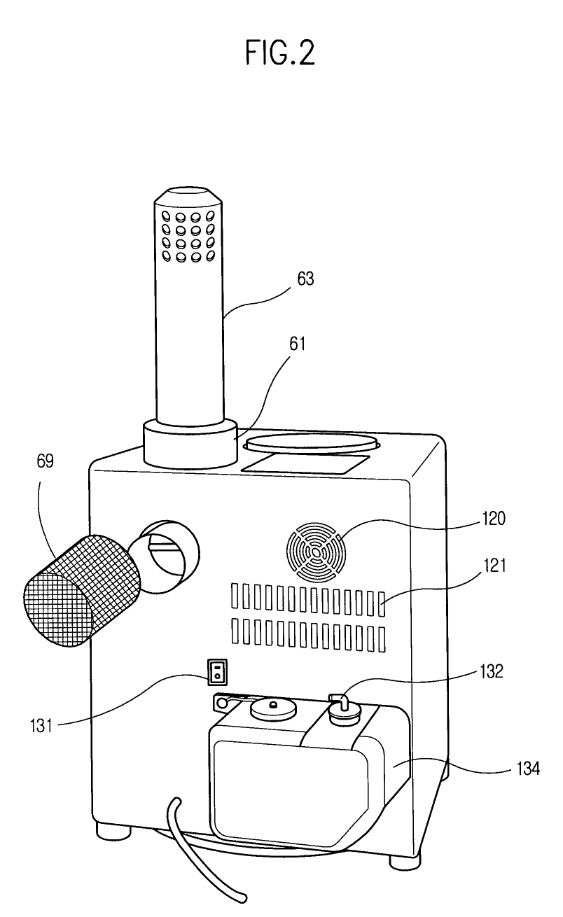

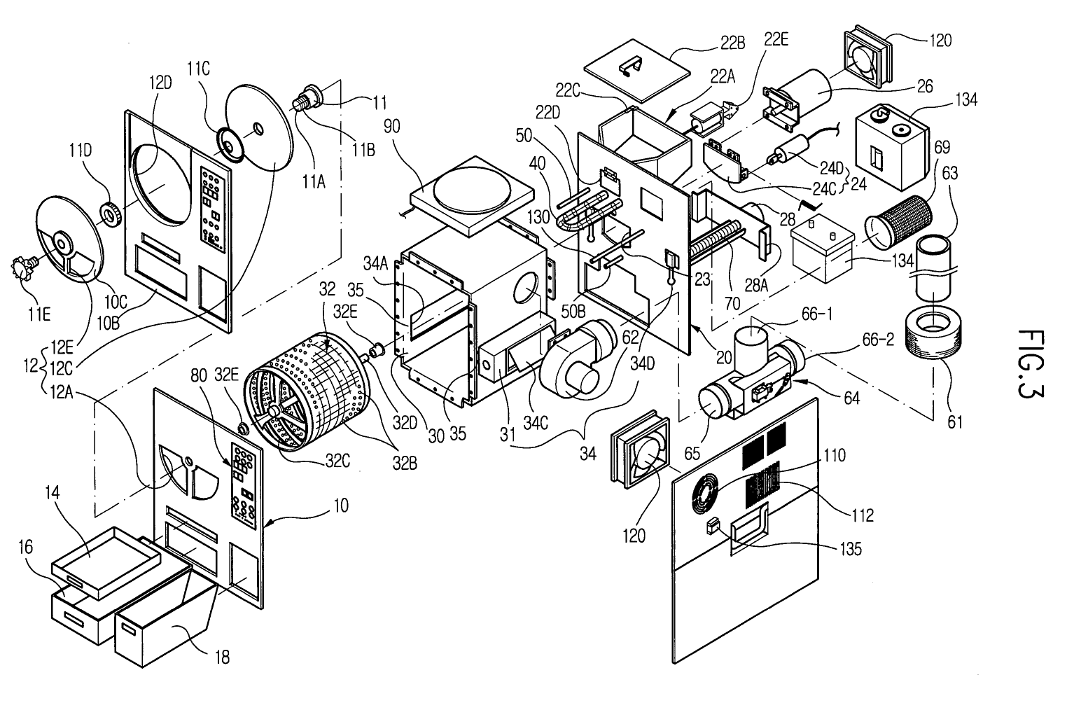

FIGS. 1 and 2 depict respectively a front view and a back view of the beans roaster according to one embodiment of the present invention.

As shown in FIG. 1, the front of the coffee roaster of present invention is composed of a viewer 12 for viewing inner part of the chamber, input buttons 80 for controlling the beans roasting process, a chaff collection tray 14, a beans collector 16, and optionally a measuring container 18 for weighting the beans.

Center of the base plane of the beans roaster is provided with a turntable 100 capable of 360-degree revolutions. The four supporters 102 around the turntable 100 are embedded at the bottom of the coffee beans roaster.

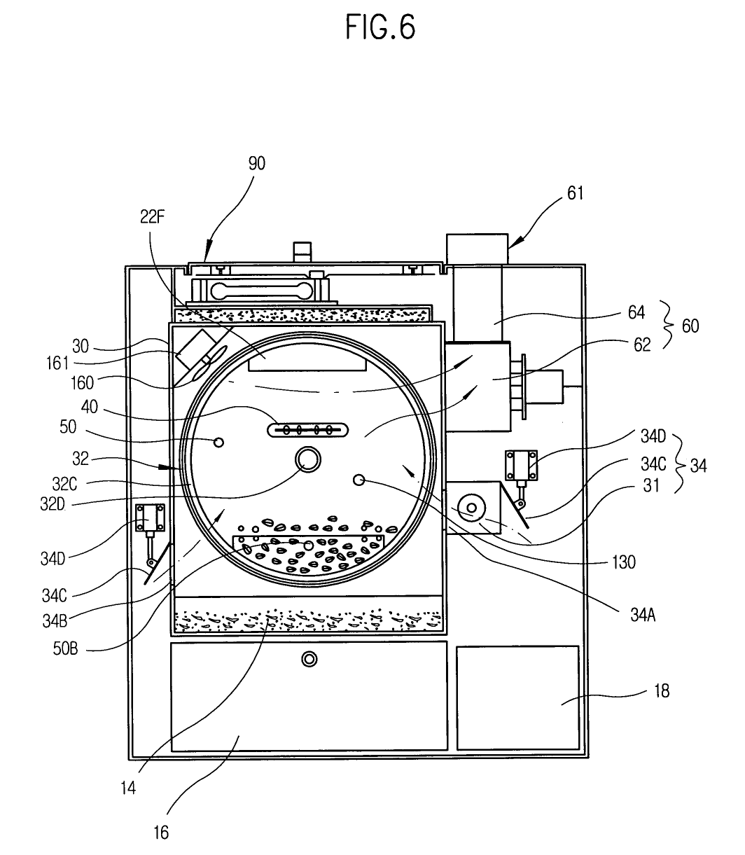

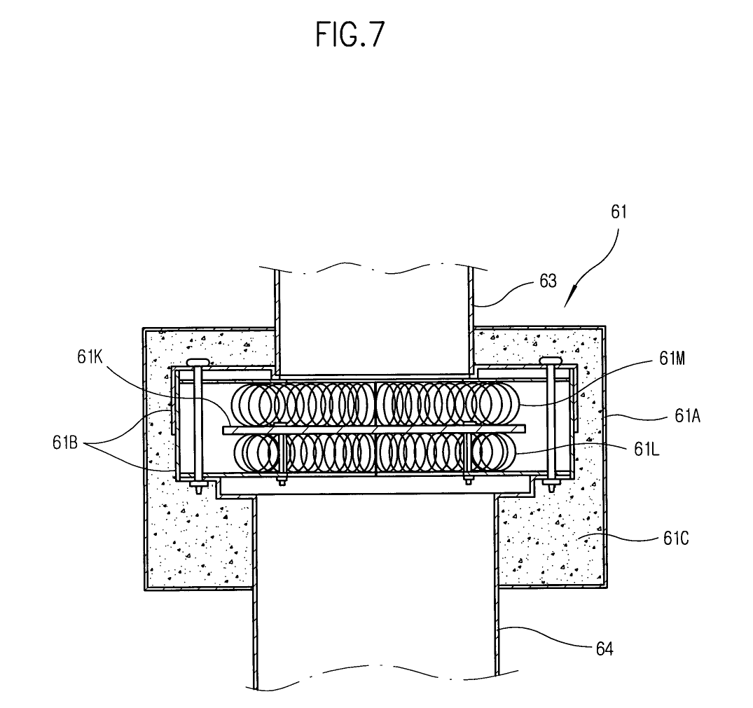

Additionally, the coffee beans roaster of the present invention is depicted in top view in order to provide an electronic scale 90; a providing means 22 for throwing raw beans, and a smoke eliminator 61 (See FIGS. 6 and 7). The top of the smoke eliminator 61 is connected to a funnel 63 according to the one embodiment of present invention (See FIG. 5). The funnel 63 shown in FIG. 5 emanates smoke of a chamber by osmotic pressure. The length of the funnel 63 is set in order to minimize the release of the heat of the chamber. When the length of the funnel 63 is increased, the heat of the chamber is released more than before because the smoke is emitted faster according to the increase of the osmotic pressure. As further preferred embodiment, the length of the funnel 63 is from 40 to 45 cm.

The top of the smoke eliminator 61 is not connected to the funnel 63 according to the other embodiment of present invention (See FIG. 6).

Shown as one side of the coffee beans roaster, the coffee beans roaster further comprises a cooling fan 110 for cooling the heated chamber, a plurality of air slot 112 for drawing ambient air and for exhausting air of the chamber, and an emergency switch 135.

As shown in FIG. 2, the back of the coffee roaster of present invention is further composed of a filter 69, a water tank 134, a water quenching switch 131, a fan 120, and a plurality of air slots 121. The filter 69 is mounted at the end of a damper 64, which is exposed through the rear of the coffee beans roaster. The water tank 134 is physically connected to a water pump (not shown), which is electrically connected to the water-quenching switch 131. When water is eliminated from the water tank 134, the water tank 134 may lose its shape by reducing inner pressure of the water tank 134. To maintain the shape of the water tank 134, a reverse L-shaped air suction port 132 is installed on a cover of the water tank 134.

FIG. 3 is perspective view showing the exploded state of the present invention.

The coffee roaster of present invention is comprised of a chamber, at least one temperature measuring means, a temperature adjusting means, a smoke exhaust means, a water provider, a driving means, and a controller.

In one preferred embodiment, the chamber 32 has a drum shape with two fully opened sides. The chamber 32 is embedded in a chamber cover member 30 located between a front supporting board 10 and a rear supporting board 20. The surface of the chamber 32 has plurality of holes 32B. A flat wire 32C is vertically installed with spiral shape in the internal surface of the chamber 32. The beans contained within the chamber 32 alternatively move forward and backward according to the rotational direction of the chamber 32. Thus, the beans mix to maintain a uniform constant temperature.

Also, two ends of a chamber shaft 32D each penetrate a radiant-shaped bracket which is fixed to the opened two end sides of the chamber 32. The two ends of a chamber shaft 32D, which penetrate the bracket, each have an oil-less metal bearing.

Furthermore, the two ends of a chamber shaft 32D are respectively mounted rotationally in a supporting member 11 and in a rotating shaft of a chamber driving member 26. A protective cap 32E surrounds the oil-less metal bearing so as to protect the oil-less metal bearing from the heat generated from a halogen light heater and to prevent fine metal power, which is generated by rotation of the axe to mix the beans.

The front supporting board 10 is a supporting structure of the chamber 32 with an input buttons 80. The front supporting board 10 also has several holes for fixing the viewer 12, and for respectively attaching and dispatching a chaff collection tray 14, a beans collector 16, and a container 18. The viewer 12 is capable of viewing the bean roasting process.

A cover member 10B assembles the front supporting board 10 so that the input buttons 80 are electrically connected to a plurality of buttons, which are located on the cover member 10B. The cover member 10B has several holes corresponding to the holes of the front supporting board 10.

The chamber shaft 32D projected onto the cover member 10B is sequentially assembled by a supporting member 11, a viewing window 12C, an elastic member 11C, a constricting nut 11D, an outer cover 10C, and a knob 11E. At this time, the outer cover 10C is capable of covering a viewing hole 12D of the cover member 10B.

The chamber cover member 30 has a hexahedron shape that is opened forward and backward. The opened sides are respectively fixed to the front supporting board 10 and the rear supporting board 20. The chamber 32 is mounted to rotate by the chamber-driving member 26 within the chamber cover member 30. Two side boards of the chamber cover member 30 establish holes for drawing and exhausting air, a cooling means 34, and an exhaust fan 62 for exhausting air backwardly.

The rear supporting board 20 is also a supporting structure of the chamber 32. The rear supporting board 20 has several holes for providing and discharging beans and for any necessities. Also, a heater 40, a first temperature sensor 50, a second temperature sensor 50B, and a nozzle 130 are fixed on the rear supporting board 20 in order to be included within the chamber 32. The heater 40 is located on upper part of the rotating shaft 32D as one of the temperature adjusting means. In this preferred embodiment, the heater 40 is a halogen light heater that is capable of controlling amount of current by predetermined conditions. In a further preferred embodiment, the heater 40 is a hot wire or a hot blast.

A providing door 22D for providing the chamber 32 with raw beans is disposed at one of the holes of the rear supporting board 20. The providing door 22D is connected to a providing means 22 for the raw beans.

Moreover, a beans discharging door (not shown) for discharging the roasted beans is also disposed at one of the holes of the rear supporting board 20. The lower door is connected to a discharging means 330.

The chaff collection tray 14 and the beans collector 16 are attached and dispatched through the rear supporting board 20. A transferring means 70 is installed on the rear supporting board 20 to be located with predetermined space beneath the chamber 32.

The temperature measuring means includes above mentioned the first temperature sensor 50 and the second temperature sensor 50B, and further a first and a second thermostat 520 and 530 which will be more thoroughly discussed below.

The first temperature sensor 50 is located on an upper part of the chamber 32 and measures the inner air temperature of the chamber 32. Hereinafter, the inner air temperature of the chamber 32 will be described as “chamber temperature”. The second temperature sensor 50B is immersed within the beans within the chamber 32 and measures the beans' temperature. The first thermostat (not shown) is fixed at the point corresponding to the chamber 32 on the rear supporting board 20. The first thermostat measures the temperature of the rear supporting board 20 which will rise accordingly as the chamber temperature increases. Thus, at a more predetermined temperature, the controller cuts off power, which is provided to the heater 40. The second thermostat is fixed to the smoke eliminator 61. At a more predetermined temperature, the controller also cuts off power which is provided to an open coil heater of the smoke eliminator 61.

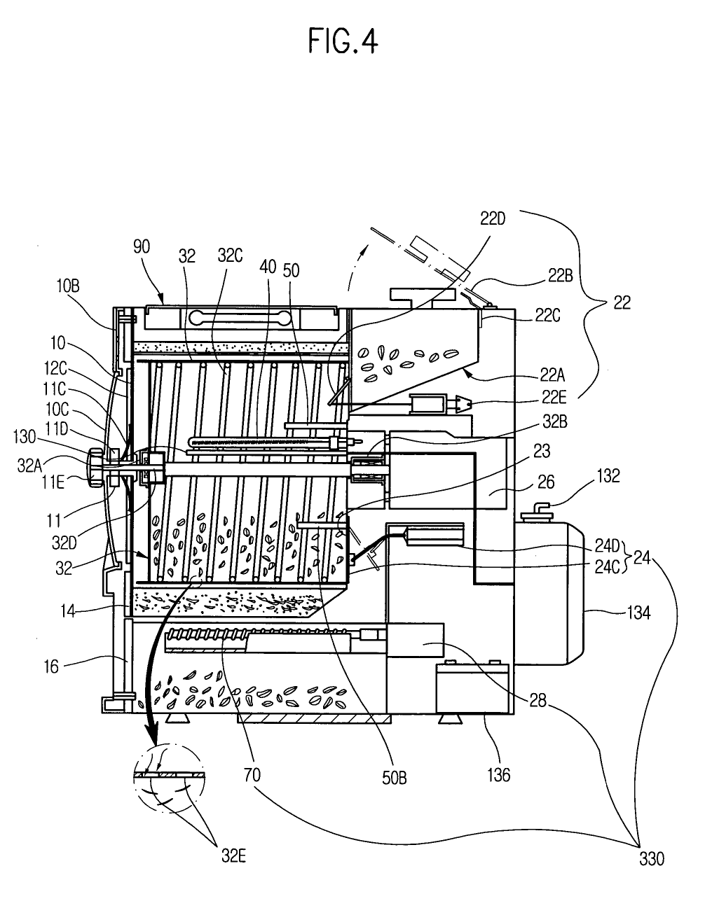

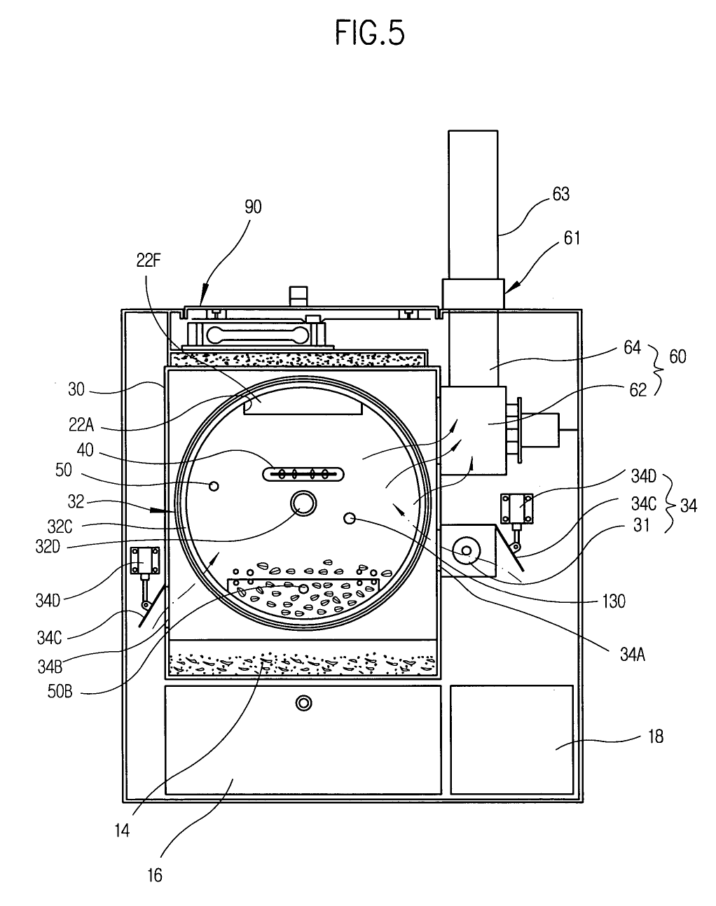

FIG. 4 is a cross-sectional side view of the coffee roaster of the present invention.

As shown in FIG. 3, the providing means 22 for the raw beans includes a hoper 22A, a hoper cover 22B, a micro-switch 22C, a providing door 22D, and an operating member 22E.

The hoper 22A has an opened top and a chute. Thus, the bottom of the hoper 22A inclines with a predetermined degree. The providing door 22D is installed on one side of the rear supporting board 20 and the hoper 22A is installed on the opposite side of the rear supporting board 20 for providing the chamber 32 with the raw beans through the providing means 22. The providing door 22D hinged at the rear supporting board 20 is opened or is closed by the operating member 22E installed under the hoper 22A. One side of the hoper cover 22B with a knob is plated for brilliance, prevention of pollution, a tarnish prevention, etc. by a plating method such as electroplate etc. which is obvious to those skilled in this art. The hoper cover 22B is also hinged at the top of the coffee roaster and is capable of covering the hoper 22A.

The micro-switch 22C is installed at an upper side of the hoper 22A. The micro-switch 22C is electronically connected to the operating member 22E, so that the providing door 22D is opened or closed by the operating member 22E according to whether the hoper cover 22B is opened or closed.

The roasting process of the raw beans loaded to the chamber 32 from the beans providing means 22 is completed and then the beans are removed from the chamber 32 by a discharging means 330. The discharging means 330 includes an opening and shuttering means 24, a transferring means 70, and a driving member 28. The opening and shuttering means 24 is comprised of a discharging door 24C, an operating means 24D for discharging beans, and an elastic matter 24B that connects between the discharging door 24C and the operating means 24D. The discharging door 24C is fixed at the rear supporting board 20 by a hinge in order to open or shutter. When a predetermined condition is satisfied, the discharging door 24C is opened or is closed by operating the operating member 24D. When the discharging door 24C opens, the transferring means 70 that is located under the chamber 32 may convey the beans to an inner front of the beans collector 16. The transferring means 70 is composed of a rotational shaft and a duct having a half-cylinder shape.

The rotational shaft on which a flat wire is spirally wounded and the duct are fixed on the rear supporting board 20 with a setting bracket 28A. The driving member 28 rotates the rotational shaft. But, the duct that is spaced from the rotational shaft fixes onto the rear supporting board 20. The body of the transferring means 70 is lengthwise installed at an inner of the beans collector 16.

In a further preferred embodiment, water is provided to the beans by water providing means in order to cool down the beans that completed the roasting process. The water providing means is composed of a nozzle 130, a water-quenching switch 131 (as shown in FIG. 2), a cover 132 of the water tank 134, a water pump (not shown), and the water tank 134. The water pump connected to the water tank 134 is connected to the nozzle 130 by a hose and also is electrically connected to the water-quenching switch 131. The stick-shaped nozzle 130 with a plurality of holes is fixed to the rear supporting board 20 in order to put in the chamber 32. The hole of the nozzle 130 points downward.

In a preferred embodiment, the water tank is capable of being connected to a water service pipe to be automatically provided with water.

FIG. 5 is showing a front cross-sectional view in order to depict the operating state of the coffee roaster according to a first embodiment of the present invention.

As shown in FIG. 5, the electronic scale 90 is installed on the coffee roaster where the thermal insulation process is completed. The electronic scale 90 is electrically connected with the input buttons 80.

A cooling means 34 includes a cool air blower 31, a blower door 34C, and a solenoid 34D for the cool air blower 31. In a further preferred embodiment, the cooling means 34 further includes an exhaust fan 62 and several cooling fans 110, 120. The cooling means 34 operates after the roasting process of the beans. Both sides of the chamber cover member 30 have respectively one of holes 34A and 34B for drawing and exhausting air.

The cool air blower 31 can be respectively installed near the holes 34A and 34B. In this preferred embodiment, the cool air blower 31 is installed near to one of the holes 34A and 34B selectively. Also, the cool air blower 31 is contained within an open box with the blower door 34C. At this time, the other hole that did not install the cool air blower 31 is also covered with a blower door (not shown). The blower door is opened and shuttered by a solenoid 34D.

The exhaust fan 62 is located on the upper side part of the chamber cover member 30. When the cooling process starts after the roasting process of the beans, a shutter of a damper is opened and the exhaust fan 62 operates with high speed at the same time for exhausting hot air backward so that the beans are cooled down. Additionally, the exhaust fan 62 is capable of operating with low speed for exhausting the smoke during the roasting process of the beans.

Additionally, the cooling fans 110 and 120 are both fixed to the upper part of the chamber 32 and operate after the roasting process.

FIG. 6 is showing a front cross-sectional view in order to depict the operating state of the coffee roaster according to a second embodiment of the present invention.

The coffee roaster shown in FIG. 6 has not a funnel 63 (see FIG. 5). In this case, during the roasting process, the exhaust fan 62 operates the low speed, for example, every 20 seconds in order to discharge the smoke of the chamber to the smoke eliminator 61.

Additionally, the coffee roaster has a ceiling fan 160 and a motor 161. The ceiling fan 160 and the motor 161 are mounted at one of upper side of the chamber 32. When the ceiling fan 160 operates continuously, the beans can not achieve optimum roasting grade by exhausting the heat of the chamber. Thus, the ceiling fan 160 operates for every predetermined seconds for exhausting the smoke located at the upper side of the chamber.

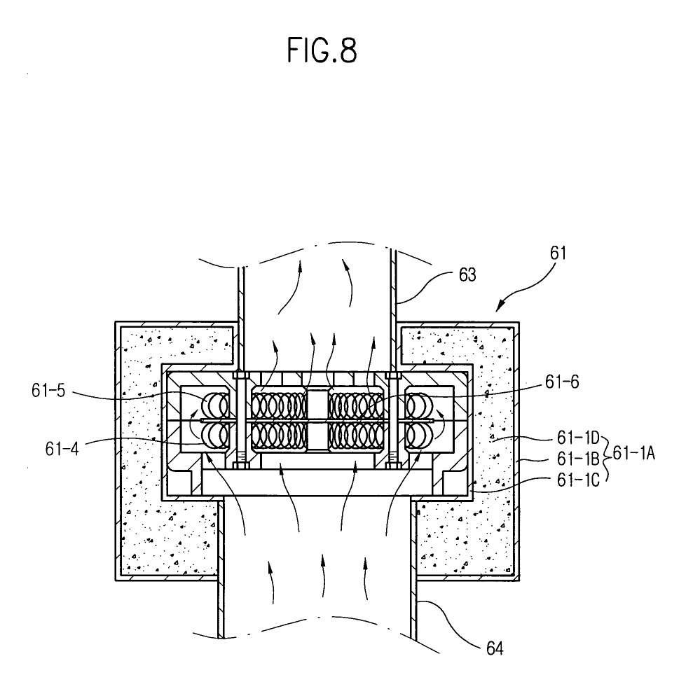

FIGS. 7 and 8 are respectively showing the smoke eliminator.

As shown FIG. 7, the smoke eliminator 61 includes an inner housing 61B, a separating plate 61K, a first open coil heater 61M, and a second open coil heater 61L.

A space between the inner housing 61B and an outer housing 61A is filled with an insulation material 61C. A top of the inner housing 61B connects to the funnel 63 and a bottom of the inner housing 61B connects also to the smoke exhausting duct 64. A separating plate 61K is mounted in the center of the inner housing 61B and has a space from the funnel 63 and the smoke exhausting duct 64 respectively. A first open coil heater 61L burns firstly the smoke streamed through the smoke exhausting duct 64. Also, a second open coil heater 61M burns secondly the first burned smoke. And then the second burned smoke exhausts through the funnel 63 to external of the coffee roaster.

As shown in FIG. 8, the smoke eliminator 61 includes an outer housing 61-1B, an inner housing 61-1C, a separating plate 61-6, a first open coil heater 61-4, and a second open coil heater 61-5.

A space between the inner housing 61-1C and the outer housing 61-1B is filled with an insulation material 61-1D. A top of the inner housing 61-1C has a plurality of holes 61-3A. And a bottom of the inner house 61-1C is connected to the smoke exhausting duct 64. A separating plate 61-6 is mounted in the center of the inner housing 61-1C and has a space from the top and the bottom of the inner house 61-1C respectively. A first open coil heater 614 burns firstly the smoke streamed through the smoke exhausting duct 64. Also, a second open coil heater 61-5 burns secondly the first burned smoke. And then the second burned smoke exhausts to external of the coffee roaster.

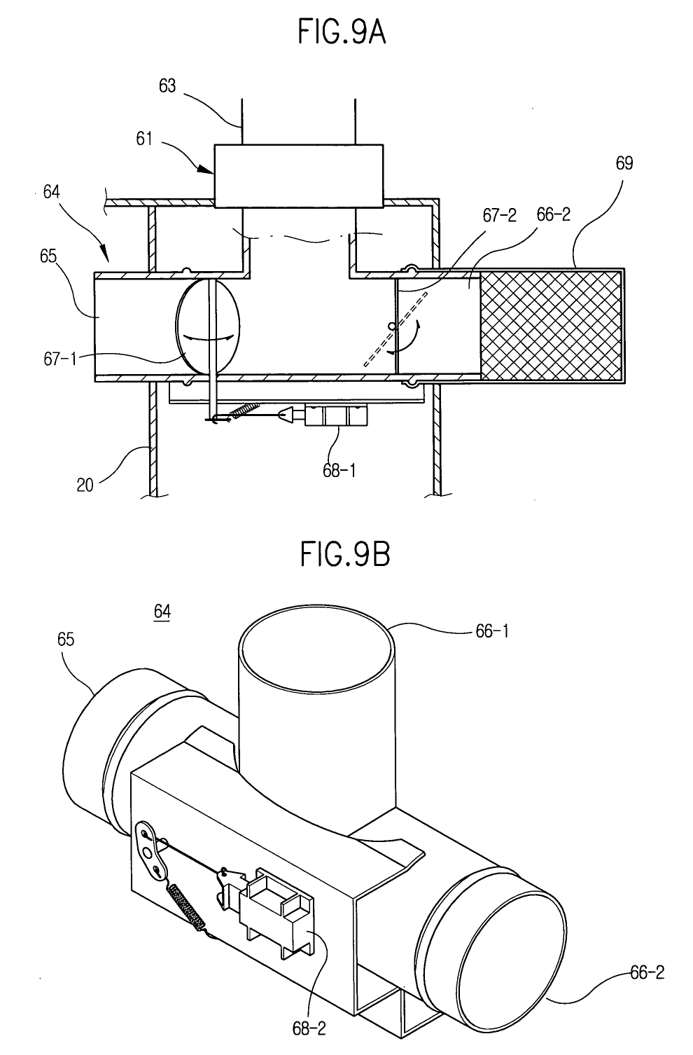

FIG. 9a and FIG. 9b are a cross sectional view and a sectional view of an exhaust duct of the coffee roaster according to present invention.

Referring to the FIGS. 9a and 9b, the damper 64 having a reverse T shape (“⊥”) is composed of an air inlet 65, a first air outlet 66-1, and a second air outlet 66-2. The air inlet 65 is connected with the exhaust fan 62 (See FIG. 3). The first air outlet 66-1 is also connected to the smoke eliminator 61 (See FIGS. 6 and 7). The second air outlet 66-2 is connected to a filter 69 that is installed through the cover of the coffee roaster. Also, a first shutter 67-1 and a second shutter 67-2 are installed in an inner duct of the damper 64. The first shutter 67-1 is located near the air inlet 65 and the second shutter 67-2 is located near the second air outlet 66-2. The first shutter 67-1 is automatically opened during a predetermined time by a first shutter solenoid 68-1, firstly when the chamber temperature becomes a predetermined temperature, and secondly when the beans' temperature reaches a first temperature during the roasting process of the beans. Lastly, the first shutter 67-1 is automatically opened again when the beans' temperature becomes a second beans' temperature. As a further preferred embodiment of the present invention, the first shutter 67-1 is opened firstly when the chamber temperature is 230 degrees centigrade for eliminating moisture contained within the beans. The first shutter 67-1 is also opened again during a maintain time when the beans temperature becomes the first beans' temperature, about 175 degrees centigrade, at which a first creak is generated. Lastly, the first shutter 67-1 is also opened again when the beans' temperature becomes the second beans' temperature, about 190 degrees centigrade. When the first shutter 67-1 is opened, the smoke discharged from the chamber moves to the smoke eliminator 61 which is connected to the first outlet 66-1. The second shutter 67-2 is opened by a second shutter solenoid 68-2 which operates after the roasting process. When the second shutter 67-2 is opened, the smoke and hot air from the chamber together move to the second outlet 66-2.

The filter 69 filters effluent exhausting from the chamber, such as shells of the beans and oil included in the smoke.

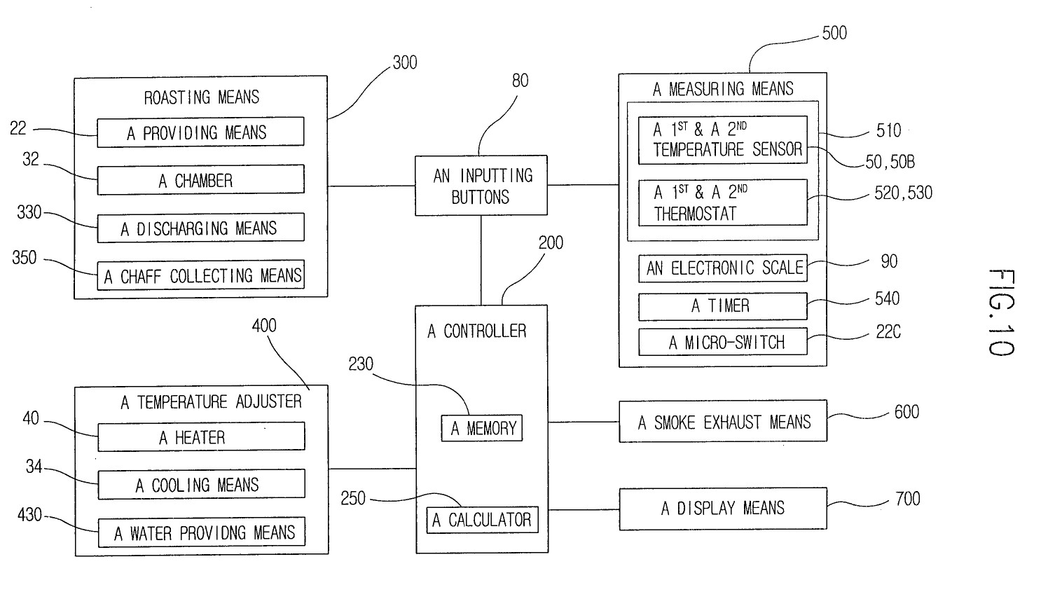

FIG. 10 is a schematic block diagram of a controlling system for the coffee roaster according to the present invention.

The controlling system includes an input means 80, a controller 200, a roasting means 300, a temperature adjuster 400, a measuring means 500, a smoke exhaust means 600, and a display means 700. The controller 200 includes a memory 230 and a calculator 250.

The input means 80 is composed of several switches and a plurality of buttons to be selectively selected by the user. In a preferred embodiment, the input means 80 includes a weight button, an automatic/manual mode button, a raw bean type button, a roasting grade button, a temperature button, a time button, a main switch, a start/stop switch, a water-quenching switch, and an emergency switch.

The roasting means 300 includes a beans providing means 22, a chamber 32, a beans discharging means 330, and a chaff collecting means 350. The chaff collecting means 350 includes a chaff collection tray, and a first and a second interlock switch 352A and 352B.

The temperature adjuster 400 includes a heater 40, a cooling means 34, and a water providing means 430.

The measuring means 500 includes a temperature measuring means 510, an electronic scale 90, a timer 540, a sensor for opening and shuttering means 550. The temperature measuring means 510 also includes a first temperature sensor 50, a second temperature sensor 50B, and a first and a second thermostat 520, 530.

The smoke exhaust means 600 includes a damper 64, a smoke eliminator 61(See FIGS. 7 and 8), and a funnel 63. In another embodiment, the smoke exhaust means 600 includes a damper 64, a smoke eliminator 61, a ceiling fan, and a motor for operating the ceiling fan, and the exhaust fan 62. The exhaust fan 62 is included in the smoke exhaust means 600 by operating during the roasting process, but the exhaust fan 62 in included in the cooling means by operating after the roasting process as well.

The display means 700 includes a voltage/temperature indicator, a time/weight indicator, a raw beans indicator, a process indicator, and a roasting indicator.

The operation according to the preferred embodiment of the present invention will be depicted as follows.

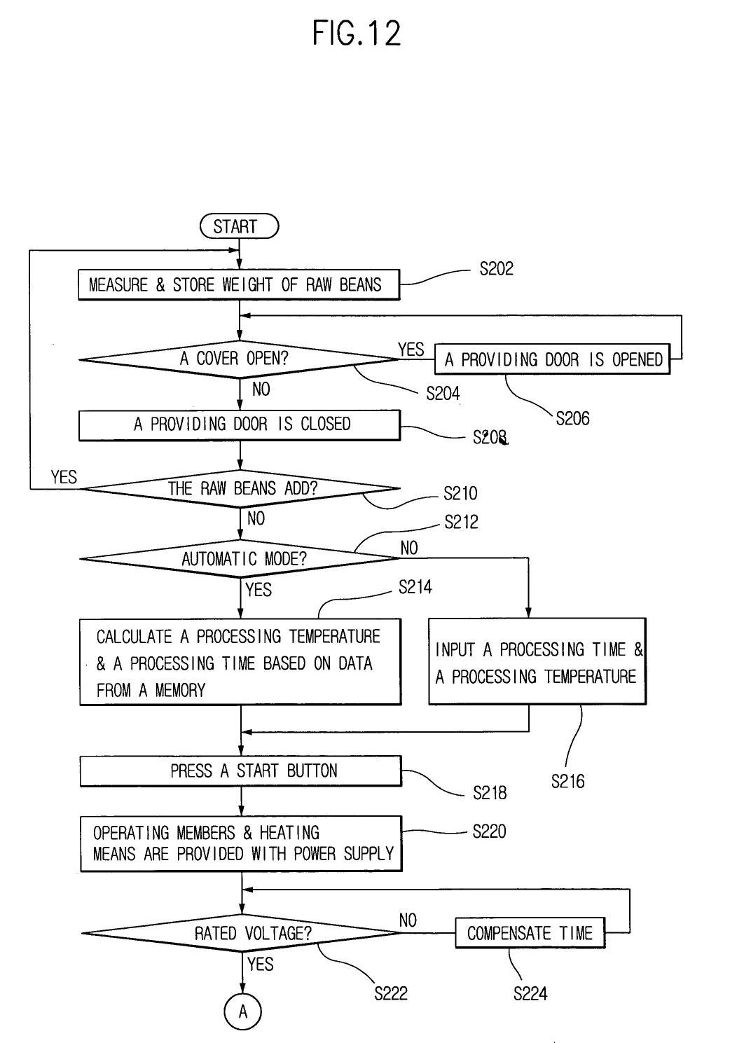

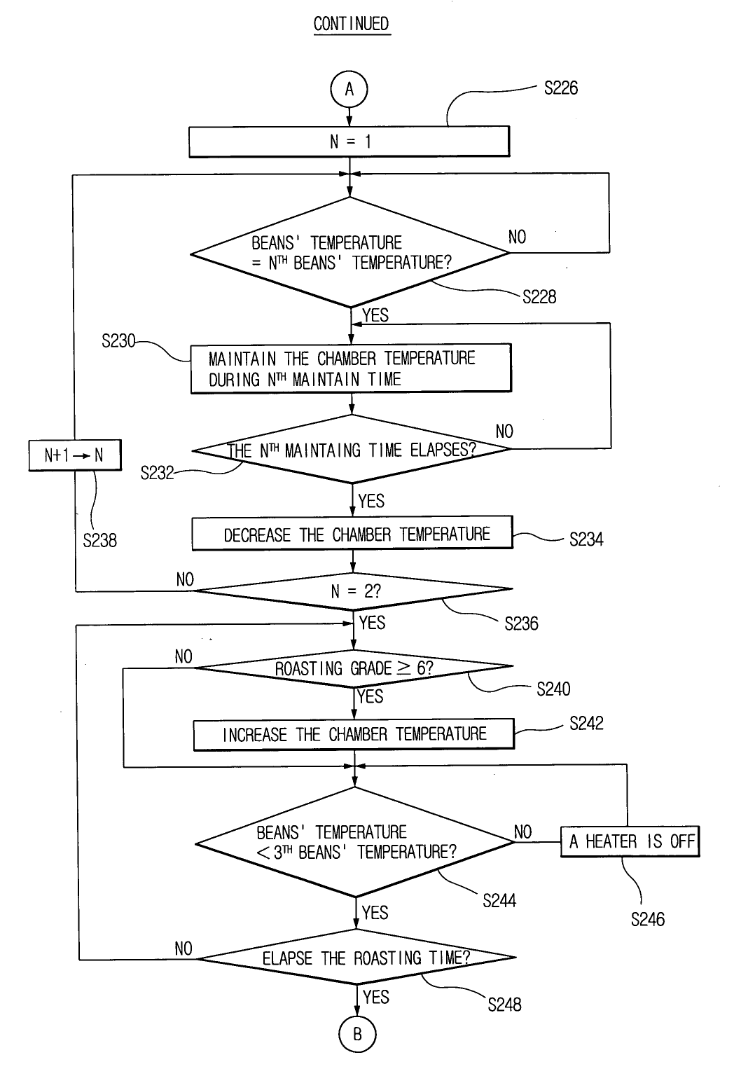

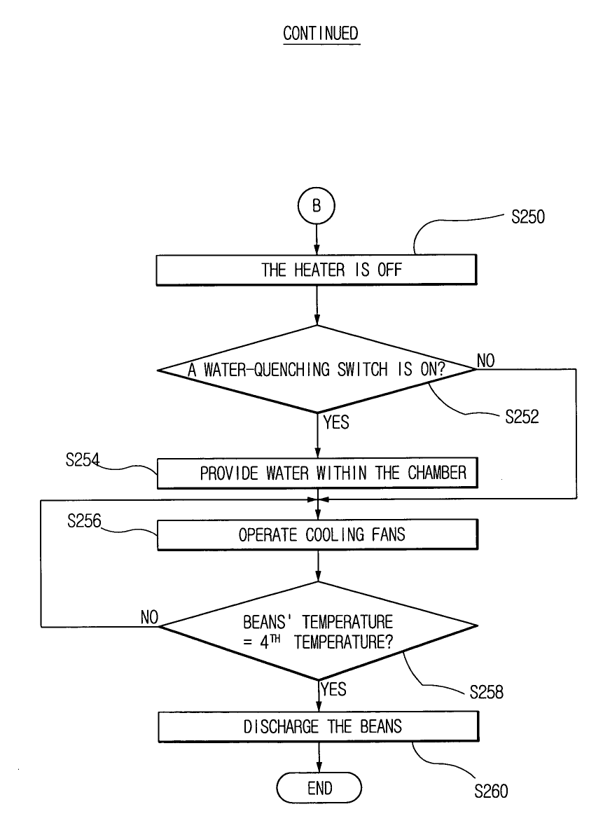

Referring to FIG. 12, when the main switch of the input means 80 is turned on, the controller 200 initializes the coffee roaster. In the initialized state, the time/weight indicator displays a measured value by the electronic scale 90 at a step S202. In order to load the raw beans in the chamber 32, the user opens a hoper cover and provides the raw beans to a hoper 22. When the hoper cover is opened, a micro-switch 22C operates operating member to open the providing door in the steps S204 and S206. When the hoper cover is closed, a micro-switch 22C operates operating member to stop the operating member in the steps S204 and S208.

To add the raw beans further in the step S210, the user weights the raw beans and then repeats the step S202 through S208. Additionally, when the raw beans have been loaded and the user selects the weight button, the weight of the raw beans is inputted into the controller 200. The controller 200 accumulates and stores the weight of the raw beans before receiving ON signal from the start/stop switch. The stored weight of the raw beans is displayed at the time/weight indicator. Furthermore, the stored weight and the number of the roasting are accumulated continuously from the first use of the coffee roaster. Thus, when the user selects predetermined buttons (not shown), the controller 200 respectively displays total weight of the raw beans roasted and the number of the roasting done in the past.

Furthermore, the controller 200 discriminates the weight of raw beans from exceeding a predetermined weight, for example, 1.5 kg. If the weight of raw beans exceeds, the controller 200 does not proceed to the next process and the error message is displayed on the time/weight indicator. Thus, all elements of the coffee roaster are prevented from overloading.

The raw beans are loaded within the chamber and then the controller 200 discriminates whether the user selected an automatic mode or a manual mode in the step S212. When the automatic mode is selected, the controller 200 calculates the processing time and the processing temperature as the step from the plurality of data in the step S214. However, the user should input the processing time and the processing temperature in the manual mode of the step S216. The processing temperature includes a first through a fourth beans' temperature, and a chamber temperature. The chamber temperature is controlled according to the first through the fourth beans' temperature.

Additionally, the first beans' temperature is calculated based on the input data from the user and by the measuring data from the measuring means 500 are stored in the memory 230. At this time, the beans' temperature is determined by the weight of the raw beans loaded in the chamber when the type of the raw beans is set in the middle type and the roasting grade is set as the middle grade, for example 8 grade. For example, when the weight of the raw beans is 400 g through 950 g, the first temperature of the beans is 175 degrees centigrade. When the weight of the raw beans is 951 g through 1500 g, the first temperature of the beans is 180 degrees centigrade. When the weight of the raw beans is 950 g, the first temperature of the beans is 180 degrees centigrade.

In a further preferred embodiment, the first beans' temperature is automatically increased or decreased according to the user's selection of type of raw beans. For example, in a first group, the raw beans have green color, bigger size and more moisture than a second and a third group. In a third group, the raw beans have brown color and smaller size, and are harder than the first and the second group. The first temperature of the first group is set about 6 degrees centigrade higher than the first temperature of the third group.

Additionally, the user can select the roasting grade before the roasting process. The roasting grade is more than one grade and is selected by using the roasting grade button of the input buttons 80.

In the step S218, the start button is pressed and the roasting process commences. When the start button is pressed, all operating members and the heating means are provided with power supply in the step S220. The process can continuously proceed until the preselected program has been run or manually terminated.

The controller 200 controls all operating members and the heating means with the timer 540 according to the processing temperature and the processing time calculated respectively at the step S214 and the step S216.

During the roasting process, the controller 200 controls the chamber to change the rotating direction periodically by the first operating member. The first operation member is a motor. The controller 200 controls the motor to rotate clockwise during a predetermined time, for example, 40 seconds and then breaks the power supply which is provided to the motor so that the motor stops. When the motor completely stops, the controller 200 also controls the motor to rotate counterclockwise during a predetermined time, for example, 60 seconds.

The controller 200 discriminates whether the applied voltage is a rated voltage in the step S222. When the applied voltage is not a rated voltage, a voltage-compensation program in the step S224 regulates the processing time. The water contained in the raw beans is completely evaporated and then the raw beans are roasted. If the applied voltage is not the rated voltage, for example, if the applied voltage is higher then the rated voltage, the chamber temperature is reached at 250 degrees centigrade faster than for the rated voltage. However, if the applied voltage is lower then the rated voltage, the chamber temperature is reached at the 250 degrees slower than for the rated voltage. Therefore, the chamber temperature maintains constantly during a compensating time, a₁ fixed by the voltage-compensation program as noted previously. For example, when the chamber temperature reaches at 230 degrees centigrade, the chamber temperature maintains the 230 degrees centigrade during the compensating time, a₁, 1 minute. The compensating time a₁ varies based on the applied voltage.

In the step S228 and S230, when the beans' temperature is the first beans' temperature, the controller 200 controls the amount of the current applied to the heater in order to maintain the chamber temperature during a first maintain time a₂. The first maintain time a₂ is calculated based on the weight of the raw beans. In the step S234, the chamber temperature drops as the first maintain time elapses, but the beans' temperature continuously increases. Thus, when the beans' temperature reaches the second beans' temperature, the chamber temperature is maintained again for a second maintain time and then the chamber temperature drops as the second maintain time elapses in the step S234 through the step S238.

In the step S240, the controller 200 discriminates whether the roasting grade is a predetermined grade or more than the predetermined grade. When the roasting grade is not inputted by the user, the roasting grade of the present roasting process becomes the roasting grade before the roasting process. In a preferred embodiment, the roasting grade is 12 grades, and higher numeral represents longer roasting time. In the step S242, when the roasting grade is 6 grade or more than 6 grade, the chamber temperature increases.

The controller 200 continuously detects the beans' temperature and discriminates whether the beans' temperature exceeds the third beans' temperature in the step S244. With the discriminating result that the beans' temperature exceeds the third beans' temperature, the heater is taken off in the step S246. Thus, the user can prevent the beans from burning. With the discriminating result of the step S244 when the temperature of the beans does not exceed the third temperature, the controller 200 discriminates also whether the roasting time has elapsed. When the roasting time has not elapsed, the steps S240, S242, S244, and S246 are repeated as shown in a step S248. When elapsed, the heater 40 turns off in a step S250.

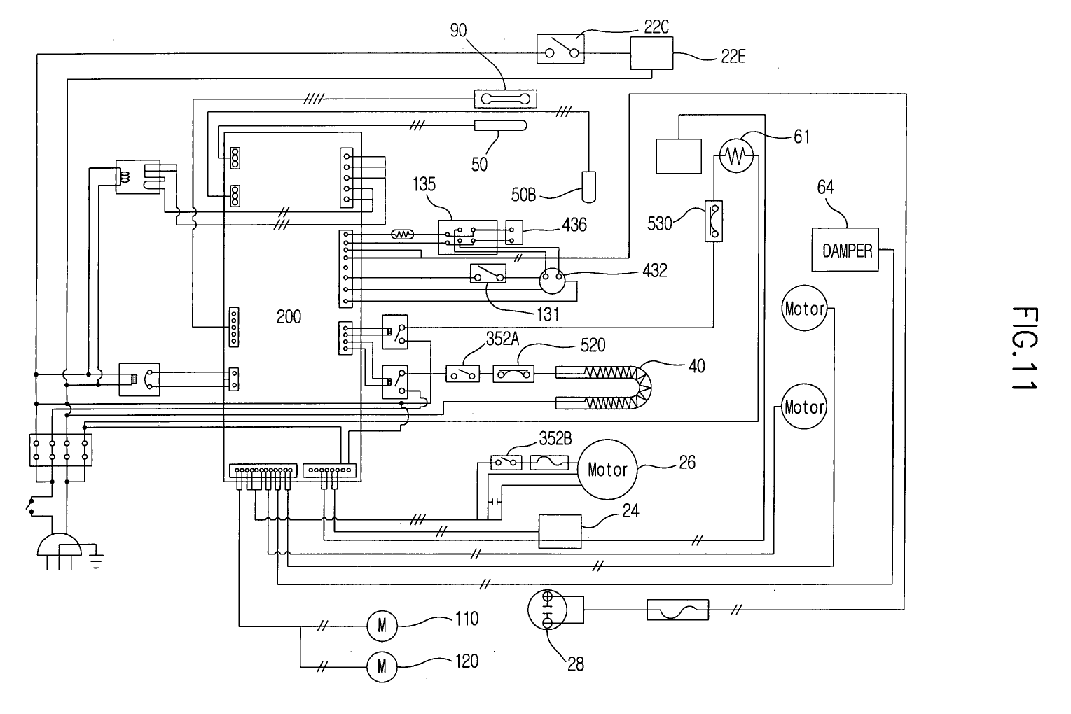

Additionally, the controller 200 discriminates whether the water-quenching switch 131 is turned on or not in a step S252. When the water-quenching switch 131 is turned off, the step S256 will proceed. Referring to the FIG. 11, when the water-quenching switch 131 is turns on; the controller 200 provides the power to the water pump driving motor 432. The water pump is operated by the water pump driving motor 432, so that water of the water tank is provided to the chamber in a step S254. At this time, amount of the water is determined by the raw beans' weight, for example, 5% of the raw beans' weight. The supply of the water is completed and the controller 200 controls the cooling fans (110, 120, See FIG. 11) to cool the beans within the chamber in a step S256.

Furthermore, the water pump driving motor 432 is connected to an emergency switch 135 and an emergency battery 436 (See FIG. 11). In a preferred embodiment of present invention, although a fire is generated within the chamber when the power is OFF, the user can push the emergency switch 135 mounted on the one side of the coffee roaster. The emergency battery 436 supplies power to the water pump driving motor 432 with the selection of the emergency switch 135, so that the water pump operates. Thus, the fire is putted out by jetting the water to the chamber by using a mounted nozzle. In a step S258, when the beans' temperature cool down as the fourth beans' temperature, the controller 200 controls the motor to rotate the chamber 32 and also controls the discharging door to open. Thus, the beans move backward and discharge out of the chamber 32 by a flat wire in a step S260. In order to stack evenly in the beans collector with the transfer means, the controller 200 controls the driving member 28.

In a further preferred embodiment of the present invention, when the roasting process is completed, the user is able to withdraw the chaff collection tray and to remove the chaff of the beans. The chaff is a natural product of any beans which completed the roasting process. When the chaff collection tray is withdrawn during the roasting process, an interlock switch 352A and 352B respectively turns off the heater 40 and a driving member 26. When the chaff collection tray is inserted again during the roasting process, an interlock switch 352A and 352B respectively turns on the heater 40 and a driving member 26.

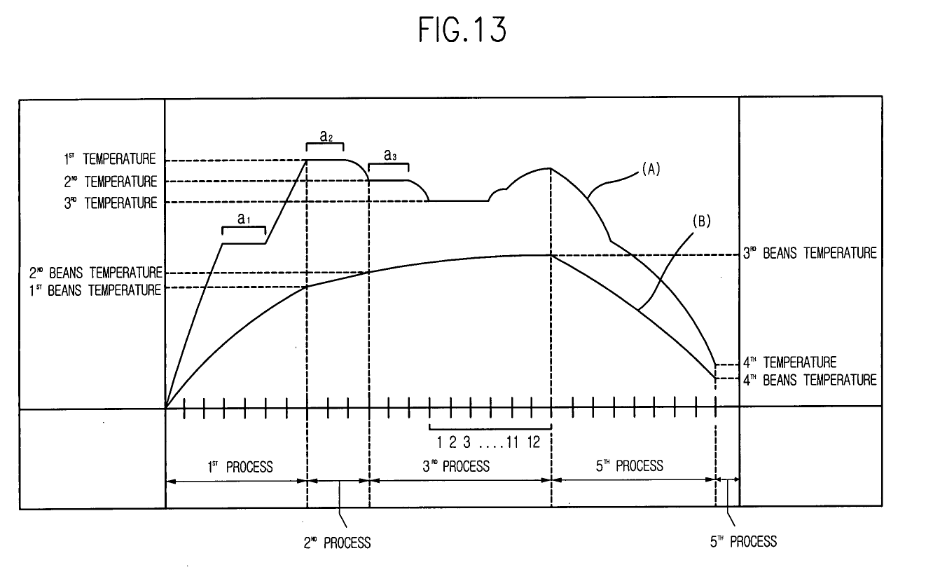

FIG. 13 is a graph of the temperature and time controlled by the flow diagram shown in FIG. 12.

The horizontal axis shows the beans process according to time and the vertical axis shows a beans' temperature and the chamber temperature. The graph (A) shows the chamber temperature, and the graph (B) shows also the beans' temperature.

The temperature of the beans changes to the first through the fourth beans' temperature according to the elapsed time and the chamber temperature adjusts according to the variation of the beans' temperature. Referring to the graph (A), moisture contained in the raw beans evaporates when the chamber temperature reaches the first chamber temperature in a first process. Hereinafter the nth chamber temperature will be described as “nth temperature”. The speed of the evaporation is proportioned to the temperature and the time, and is changed by amount of the beans.

In the first process, the chamber temperature is increased until a first temperature that is empirically obtained. At this time, the controller discriminates whether the applied voltage is the rated voltage. When the rated voltage is applied, the chamber temperature is maintained at a predetermined chamber temperature during a compensating time a₁. However, when the voltage is not the rated voltage, the compensating time a₁ is adjusted by using the voltage compensation program. The compensating time a₁ becomes longer when the higher voltage than the rated voltage is applied.

When the beans' temperature reaches the first beans' temperature, a second process step commences. In the second process step, “first crack” is generated from the beans so that the chamber temperature is maintained during a first maintain time a2 (See a reference symbol a2 of the graph (A)). The first crack is an audible sound to occur from the beans. The first maintain time a2 is able to be adjusted by the user and is preferably calculated by the following formula 1. After elapsing the first maintain time a2, the chamber temperature is dropped by a predetermined temperature, preferably 10 degrees centigrade.

y_{A}=0.1 (x_{A}−400)+20 [FORMULA 1]

y_{A}: time (second)

x_{A}: the weight of raw beans (g) (Condition: 400 g≦x_{A}≦1500 g)

When the beans' temperature reaches the second beans temperature, a third process step commences. In the third process step, the chamber temperature is maintained during a second maintain time a₃ (See a reference symbol a₃ of the graph (A)). The second maintain time a₃ is basically set by 60 seconds but the user is able to adjust within a predetermined range.

After the second maintain time a₃ elapses, the chamber temperature is reduced to a predetermined degree, preferably degrees centigrade. The third process step is the last step of the roasting process. In the manual mode, the third process time is set according to the process time inputted by the user, and in the automatic mode, the third process time is set according to the roasting grade input also by the user. However, when the user does not select the roasting grade in the automatic mode, the roasting grade is set by the before roasting grade. In an embodiment of present invention as shown in FIG. 13, the user selects the 12 grades. When the user selects more than 6 grades, the air temperature of the chamber is increased in order to run the beans' oil. Moreover, the chamber temperature should be adjusted not to reach the temperature at which the beans burn out in the third process.

Thus, when the beans' temperature is the third beans' temperature, the beans' temperature is adjusted by cutting the power supply provided to the heating means mounted within the chamber.

After the third processing step, the beans are cooled in a fourth processing step so that when the beans' temperature is the fourth beans' temperature, the beans are discharged from the chamber in the fifth processing step.

Therefore, the user does not need to continuously keep the roasting process.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. An apparatus for roasting beans comprising:
a chamber for containing beans;
a temperature adjusting means for heating or cooling the beans and the chamber;
a temperature measuring means for measuring a temperature of the beans and a temperature of the chamber;
a controller for calculating a first temperature of the beans and a first maintain time based on the weight and the type of raw beans,
and for controlling the temperature adjusting means in order to maintain the temperature of the chamber as a first chamber temperature during the first maintain time when the temperature of the beans reaches the first temperature of the beans.

2. The apparatus according to claim 1 further comprising a water provider, wherein the water provider comprises:
a water tank for containing water;
a water pump located on one-side of the water tank for outputting the water; and
a nozzle located on an inner or an outer of the chamber for providing the beans of which the roasting process is completed with the water outputted from the water pump,
wherein the controller calculates an amount of the water according to the weight of the raw beans, and the controller controls the water pump to operate so as to shoot out the calculated amount of the water through the nozzle after the roasting process.

3. The apparatus according to claim 1 wherein the chamber comprising:
a flat wire fixed vertically and spirally in the chamber which has plurality of holes for transferring the beans toward or backward according to the rotational direction; and
metal bearings having each protective cab fixed in the two ends of an axis of the chamber,
wherein the controller repeatedly controls a motor for driving the chamber, the motor is controlled in order to rotate the chamber in one direction during a first predetermined time, and then in order to rotate the chamber in the other direction during a second predetermined time when the motor is completely stopped.

4. The apparatus according to the claim 1, wherein the temperature adjusting means for heating is a halogen light heater.

5. The apparatus according to the claim 1 further comprising:
a cool air blower mounded under the chamber for blowing into the chamber external air; and
an exhaust fan for exhausting inner air of the chamber, wherein the exhaust fan operates with a first speed in order to exhaust smoke within the chamber during the roasting process, and the exhaust fan operates with a second speed in order to cool down the beans after the roasting process, wherein the first speed is slower than the second speed.

6. The apparatus according to the claim 1 further comprising a damper which comprises a first shutter located near the air inlet for exhausting smoke of the chamber by being automatically opened according to predetermined conditions; and
a second shutter located parallel with the first shutter for being automatically opened when the roasting process is completed,
wherein the first shutter is firstly opened during a predetermined time when the temperature of the chamber becomes a predetermined temperature, and is secondly opened during the first maintain time when the temperature of the beans becomes the first temperature of the beans, and is lastly opened when the temperature of the beans becomes a second temperature of the beans.

7. The apparatus according to the claim 1 further comprising a smoke exhaust means for burning and exhausting smoke generated during the roasting process.

8. The apparatus according to the claim 7 wherein the smoke exhaust means comprises:
a smoke eliminator for burning the smoke discharged from the chamber; and
a funnel for exhausting the smoke burnt in the smoke eliminator.

9. The apparatus according to the claim 8, wherein the smoke eliminator includes:
an inner housing for connecting to the funnel and to a smoke exhausting duct at the upper part and the lower part respectively;
a separating plate mounted in the center of the inner housing having a space from the funnel and the smoke exhausting duct respectively;
a first open coil heater for firstly burning the smoke streamed by through the smoke exhausting duct; and
a second open coil heater for secondly burning the first burned smoke, wherein the second burned smoke exhausted through the funnel to external of the coffee roaster.

10. The apparatus according to the claim 7 wherein the smoke exhaust means comprises:
an exhaust fan mounted on the upper right side or left side of the chamber for periodically operating during a predetermined time period; and
an smoke eliminator for burning the smoke exhausted by operating the exhaust fan.

11. The apparatus according to the claim 10, wherein the smoke eliminator includes:
an inner housing including a bottom connected to the smoke exhausting duct and a top having a plurality of holes;
a separating plate mounted in the center of the inner housing having a space from the top and the bottom respectively;
a first open coil heater for firstly burning the smoke streamed by through the smoke exhausting duct; and
a second open coil heater for secondly burning the first burned smoke.

12. The apparatus according to the claim 1 further comprising a turntable located at the center of the base plane for rotating.

13. The apparatus according to the claim 1 further comprising a providing means for providing the raw beans into the chamber, wherein the providing means comprises:
a hopper for loading the raw beans into the chamber;
a cover hinged at a top of the hopper and attaching a mirror at an inner side; and
a micro-switch for opening or shuttering an providing door located between the hopper and the chamber accordingly as whether the cover is opened or shuttered.

14. The apparatus according to the claim 1 further comprising a discharging means which is composed of:
a discharging door located at the lower part of the chamber for discharging the beans from the chamber by being opened during a predetermined time period when the temperature of the beans is at a predetermined temperature; and
a transferring means lengthwise mounted under the chamber for moving the beans to the front part of the beans collector.

15. The apparatus according to the claim 14 wherein the transferring means is composed of:
a rotational shaft having a flat wire which winds spirally on circumference of the rotational shaft; and
a duct having a half-cylinder shape and mounted under the rotational shaft.

16. The apparatus according to the claim 14 further comprising:
a chaff collection tray mounted under the chamber for collecting a chaff dropped through the plurality of holes of the chamber; and
an interlock switch for turning on or off the heater and the motor by detecting whether the chaff collection tray is inserted or withdrawn from the coffee roaster body.

17. A method for roasting beans, the method comprising steps of:
a) storing weight of raw beans;
b) discriminating whether certain type of the raw beans has been inputted;
c) calculating a first temperature of beans and a first maintain time based on the weight of the raw beans and the type of the raw beans according to the discriminated result; and
d) adjusting a temperature of the beans and a temperature of a chamber by heating or cooling;
wherein the step d) includes the steps of:
d-1) maintaining the temperature of the chamber as a first chamber temperature during the first maintain time when the temperature of the beans reaches the first temperature of the beans; and
d-2) adjusting the temperature of the beans which is lower than a predetermined temperature of the beans.

18. The method according to the claim 17 wherein the step c) includes steps of:
c-1) automatically being set as a predetermined type when the type of the raw beans is unselected in a discriminated result of the step b);
c-2) setting on a basis of the first temperature of the beans when the type of the raw beans is the predetermined type and the weight of the raw beans exceeds a predetermined weight; and
c-3) decreasing the first temperature of the beans by a predetermined degrees when the weight of the raw beans is less than the predetermined weight.

19. The method according to the claim 18 wherein the step c) further includes step of c-4) increasing or decreasing the first temperature of the beans according to selection of the type of the raw beans when the type of the raw beans is inputted by the user.

20. The method according to the claim 17 wherein the step d) further includes step of:
d-3) decreasing or increasing a time period based on the an applied voltage when the temperature of the chamber is a predetermined temperature.
